(19) United States
(12) Patent Application Publication
(10) Pub. No.: US 2014/0323259 A1
(43) Pub. Date: Oct. 30, 2014

(54) ELECTRIC DRIVE DEVICE FOR VEHICLE

(71) Applicants: Masataka Sugiyama, Toyota-shi (JP); Hiroaki Kimura, Toyota-shi (JP)

(72) Inventors: Masataka Sugiyama, Toyota-shi (JP); Hiroaki Kimura, Toyota-shi (JP)

(73) Assignee: TOYOTA JIDOSHA KABUSHIKI KAISHA, Toyota-shi, Aichi (JP)

(21) Appl. No.: 14/357,391

(22) PCT Filed: Nov. 10, 2011
(86) PCT No.: PCT/JP2011/075946

§ 371 Date: Jul. 10, 2014

(51) Int. Cl. B60K 1/00

(52) U.S. Cl. CPC B60K 1/00
USPC 475/150

(57) ABSTRACT

A vehicle electric drive device has an electric motor and is disposed with an engagement device between each end of an output shaft of the electric motor and each of left and right drive wheels, the vehicle electric drive device being disposed with a planetary gear device between each end of the output shaft of the electric motor and each of the left and right drive wheels, the engagement device being a brake fixing one rotating element of the planetary gear device to reduce rotation of the output shaft of the electric motor, the planetary gear device being made up of the sun gear coupled to the output shaft of the electric motor, the stepped pinion having the small-diameter gear and the large-diameter gear such that the large-diameter gear is meshed with the sun gear, the carrier supporting the stepped pinion rotatably and revolvably around the sun gear and coupled to the drive wheel, and the ring gear meshed with the small-diameter gear of the stepped pinion, and the engagement devices being disposed between the ring gear and a non-rotating member.

### TECHNICAL FIELD

The present invention relates to a vehicle electric drive device and particularly to a structure of an electric drive device with a higher degree of freedom in design.

### BACKGROUND ART

A vehicle electric drive device is known that has an electric motor coupled to left and right drive wheels in a power transmittable manner to drive the drive wheels with the electric motor. For example, an electric vehicle drive device described in Patent Document 1 is an example thereof An electric vehicle drive device 1 described in Patent Document 1 includes a motor 2 having a rotor shaft 23, a planetary gear 3 arranged coaxially with the rotor shaft 23 to reduce and output rotation of the motor 2, and a differential device 4 arranged coaxially with the rotor shaft 23 to transmit an output of the planetary gear 3 to left and right drive wheels.

### PRIOR ART DOCUMENTS

### Patent Documents

Patent Document 1: Japanese Laid-Open Patent Publication No. 8-48164
Patent Document 2: Japanese Laid-Open Patent Publication No. 5-147445
Patent Document 3: Japanese Laid-Open Patent Publication No. 2011-31746

### SUMMARY OF THE INVENTION

### Problem to Be Solved by the Invention

The electric vehicle drive device 1 of Patent Document 1 has the planetary gear 3 and the differential device 4 disposed on one axial side of the motor 2. One of the left and right drive wheels is coupled to the differential device 4 via a drive shaft 11 (intermediate shaft) penetrating through an inside of the rotor shaft 23. Since the planetary gear 3 and the differential device 4 are disposed on one axial side of the motor 2, the drive device 1 tends to axially elongate and reduces a degree of freedom in design, causing a problem of difficulty in centroid design of the motor 2, which is a heavy load, in particular. In Patent Documents 2 and 3, two electric motors are respectively coupled to left and right drive wheels to enable elimination of the differential device; however, since the two electric motors are required in both cases, causing a problem of increased vehicle weight.

The present invention was conceived in view of the situations and it is therefore an object of the present invention to provide a vehicle electric drive device with a higher degree of freedom in design.

### Means for Solving the Problem

To achieve the object, the first aspect of the invention provides (a) a vehicle electric drive device having an electric motor coupled to drive wheels in a power transmittable manner to drive left and right drive wheels with the electric motor, (b) the electric motor having an output shaft coupled at both respective ends to the left and right drive wheels, (c) the vehicle electric drive device being disposed with an engagement device between each end of the output shaft of the electric motor and each of the left and right drive wheels, the engagement device allowing a differential motion of each of the left and right drive wheels.

### Effects of the Invention

Consequently, since the engagement device is disposed between the output shaft of the electric motor and each of the left and right drive wheels and the engagement device allows a differential motion of each of the left and right drive wheels, the slip ratio of the engagement device can be changed to apply a rotation speed difference to the left and right drive wheels as is the case with a differential device without disposing the differential device. Since the differential device can be eliminated in this way, the degree of freedom in design becomes higher and the centroid design of the electric motor is facilitated. Since this also eliminates the intermediate shaft that is required when the differential device is disposed on one axial side of the electric motor and that penetrates through an inside of the output shaft of the electric motor to be coupled to the drive wheel, the degree of freedom in design is further increased.

Preferably, the second aspect of the invention provides the vehicle electric drive device recited in the first aspect of the invention, wherein the vehicle electric drive device is disposed with a planetary gear device between each end of the output shaft of the electric motor and each of the left and right drive wheels, and wherein the engagement device is a brake fixing one rotating element of the planetary gear device to reduce rotation of the output shaft of the electric motor. Consequently, the planetary gear devices and the brakes make up the reduction gears, and the rotation of the output shaft of the electric motor can be reduced and transmitted to the drive wheels by engaging the brakes to stop the rotation of the one rotating element. When the planetary gear devices and the brakes act as the reduction gears, the output torque of the electric motor can be made smaller and, therefore, the electric motor can be reduced in size. Since the engagement devices are the brakes stopping the rotation of the one rotating element, the device can be simplified as compared to a clutch, which couples rotating rotational elements to each other.

Preferably, the third aspect of the invention provides the vehicle electric drive device recited in the second aspect of the invention, wherein the electric motors, the planetary gear devices, and the left and right drive wheels are arranged on one axis. Consequently, the device can be restrained from increasing in size in a radial direction.

Preferably, the planetary gear device is made up of the sun gear coupled to the output shaft of the electric motor, the stepped pinion having the small-diameter gear and the large-diameter gear such that the large-diameter gear is meshed with the sun gear, the carrier supporting the stepped pinion rotatably and revolvably around the sun gear and coupled to the drive wheel, and the ring gear meshed with the small-diameter gear of the stepped pinion, and the engagement devices are disposed between the ring gear and a non-rotating member. As a result, the reduction gear capable of significant speed reduction can be configured.

Preferably, controlling the torque capacities of the engagement devices preferably can bring not only the purpose of applying a rotation speed difference to the left and right drive wheels, but also a function as a differential limitation device or a drive force distribution device, for example.

### BRIEF DESCRIPTION OF THE DRAWINGS

FIG. 1 is a cross-sectional view of a vehicle electric drive device to which the present invention is preferably applied.

FIG. 2 is a cross-sectional view of a vehicle electric drive device of another example of the present invention.

FIG. 3 is a cross-sectional view of a vehicle electric drive device of yet another example of the present invention.

### MODE FOR CARRYING OUT THE INVENTION

An embodiment of the present invention will now be described in detail with reference to the drawings. In the following example, the figures are simplified or deformed as needed and portions are not necessarily precisely depicted in terms of dimension ratio, shape, etc.

### FIRST EXAMPLE

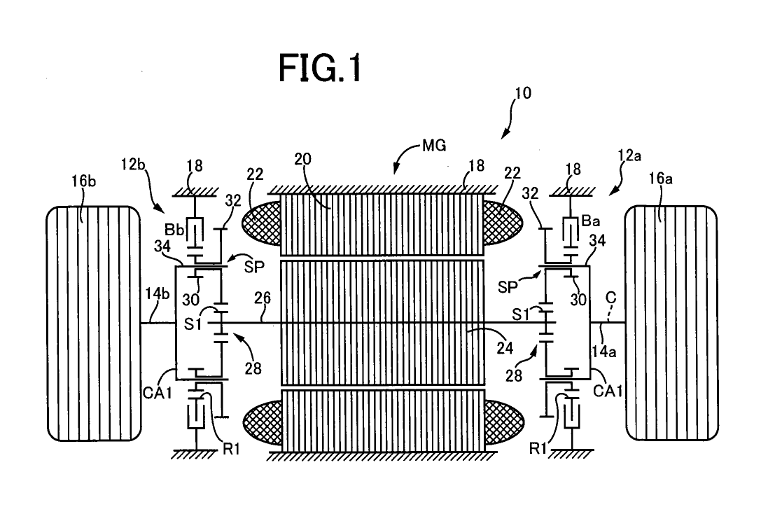

FIG. 1 is a cross-sectional view of a vehicle electric drive device 10 (hereinafter, an electric drive device 10) to which the present invention is preferably applied. The electric drive device 10 mainly includes an electric motor MG, a pair of transmissions 12a, 12b disposed on both axial sides of the electric motor, and a pair of left and right drive wheels 16a, 16b coupled to a pair of left and right axles 14a, 14b also acting as output shafts of a pair of the transmissions 12a, 12b. When no particular distinction is made, the transmissions 12a, 12b, the axles 14a, 14b, and the drive wheels 16a, 16b will hereinafter be referred to as transmissions 12, axles 14, and drive wheels 16, respectively. In this example, the electric motor 12, the transmission 14, and the drive wheels 16 are disposed on the same axial center C.

The electric motor MG mainly includes a stator 20 non-rotatably fixed to a case 18 that is a non-rotating member, a pair of left and right coil ends 22 disposed on both axial sides of the stator 20, a rotor 24 disposed on an inner circumferential side of the stator 20, and an output shaft (rotor shaft) 26 coupled to an inner circumference of the rotor 24 to be rotatable around the axial center C. The rotor 24 and the output shaft 26 coupled thereto are rotationally driven around the axial center C depending on a drive current supplied from an inverter not depicted. The output shaft 26 axially extends from both left and right ends of the electric motor MG and is coupled at both respective ends to the transmissions 12a and 12b.

The transmission 12a mainly includes a planetary gear device 28a and a brake Ba that is an engagement device. The planetary gear device 28a is a known stepped pinion type planetary gear device. Specifically, the planetary gear device 28a mainly includes a sun gear S1 coupled to the output shaft 26 of the electric motor MG, a stepped pinion SP integrally having a small-diameter gear 30 and a large-diameter gear 32 such that the large-diameter gear 32 is meshed with the sun gear S1, a carrier CA1 supporting the stepped pinion SP via a pinion shaft 34 rotatably and revolvably around the sun gear S1 (around the axial center C) and coupled via the axle 14a to the drive wheel 16a, and a ring gear R1 meshed with the small-diameter gear 30 of the stepped pinion SP.

The brake Ba is disposed between the ring gear R1 and the case 18 that is a non-rotating member. The brake Ba is a well-known multi-plate brake having an engagement state controlled by a supplied oil pressure (engagement oil pressure) and a torque capacity of the brake Ba can be controlled by controlling the engagement oil pressure supplied to the brake Ba. For example, if no oil pressure is supplied to the brake Ba, the brake Ba is opened and coupling between the ring gear R1 and the case 18 is interrupted. In this case, the planetary gear device 28a is in an idling state and power from the electric motor MG is not transmitted to the axle 14a.

On the other hand, if an oil pressure is supplied to the brake Ba, slip engagement or complete engagement is achieved between the ring gear R1 and the case 18 depending on the oil pressure. In this case, the power of the electric motor MG is transmitted via the axle 14a to the drive wheel 16a depending on the engagement oil pressure of the brake Ba, i.e., the torque capacity of the brake Ba. For example, if the brake Ba is completely engaged, rotation of the electric motor MG is changed and output to the axle 14a based on a gear ratio mechanically set in the planetary gear device 28a. The transmission 12a of this example is made up of the stepped pinion type planetary gear device 28a and therefore enables significant speed reduction. Thus, rotation of the output shaft 26 of the electric motor MG is significantly reduced and transmitted to the axle 14a. Since the transmission 12a acts as a reduction gear in this way, output torque of the electric motor MG can be made smaller and the electric motor MG can be reduced in size.

Since a hydraulic chamber is formed in the case 18 and the hydraulic chamber does not rotate, the brake Ba generates no centrifugal oil pressure from the hydraulic chamber. Therefore, no canceller chamber needs to be disposed for canceling the centrifugal oil pressure, and the transmission 12a is simplified.

The transmission 12b mainly includes a planetary gear device 28b and a brake Bb that is an engagement device. Structures of the planetary gear device 28b and the brake Bb are not changed from the planetary gear device 28a and the brake Ba described above and are therefore denoted by the same reference numerals and will not be described. Since the same structures are used for the planetary gear device 28a and the planetary gear device 28b, as well as the brake Ba and the brake Bb, and therefore enable usage of common components, manufacturing cost can be suppressed. In the electric drive device 10 of this example, gear ratios of the transmission 12a and the transmission 12b are the same values, and the brake Ba and the brake Bb are configured to be independently controllable.

An operation of the electric drive device 10 configured as described above will be described. For example, during straight running, both the brake Ba and the brake Bb can completely be engaged to eliminate a rotation speed difference between the left and right drive wheels 16a and 16b. During turning, a slip ratio of the brake Ba and the brake Bb is changed such that an optimum rotation speed difference between the left and right drive wheels 16a and 16b is applied depending on a steering angle θ of a steering wheel operation by a driver and a vehicle speed V. In other words, differential motions of the left and right drive wheels 16a and 16b are allowed by the brakes Ba and Bb. For example, while rotation speeds of the left and right drive wheels 16a and 16b are sequentially detected during turning, engagement oil pressures (torque capacities) of the brakes Ba and Bb are subjected to feedback control such that a rotation speed difference sequentially calculated from the rotation speeds is set to an optimum rotation speed difference.

As described above, the electric drive device 10 can independently control the brakes Ba and Bb to change the slip ratio, thereby applying a rotation speed difference to the left and right drive wheels 16a and 16b. Therefore, this eliminates necessity of a differential device disposed on a conventional vehicle for applying a rotation speed difference to the left and right drive wheels 16a and 16b. As a result, a degree of freedom in design of the electric drive device 10 becomes higher and a centroid design is facilitated in terms of an arrangement position of the electric motor MG. Additionally, this also eliminates necessity of an intermediate shaft penetrating through the output shaft (rotor shaft) of the electric motor to couple one output shaft of a conventionally disposed differential device and one drive wheel. Since high torque is transmitted, the intermediate shaft has a larger shaft diameter and tends to increase the entire size of the electric drive device 10; however, since the intermediate shaft is no longer necessary, the electric drive device 10 can be configured with a smaller size.

While the electric drive device 10 can apply a rotation speed difference (as a differential mechanism), the electric drive device 10 can also be controlled to have a differential limitation function as needed. Since the torque capacities of the brake Ba and the brake Bb can independently be controlled, the electric drive device 10 can freely adjust drive force distribution of the left and right drive wheels 16a and 16b in a range of 0 to 100%. Therefore, the same running state as the case of actuating a differential limitation device can be realized by controlling the respective torque capacities of the brake Ba and the brake Bb to adjust the drive force distribution. For example, if a driver selects a sport running mode, a turning performance desired by the driver can be acquired (turning performance is improved) by controlling the torque capacities of the brake Ba and the brake Bb to achieve the drive force distribution in the case of actuating the differential limitation device during turning.

For example, by using the vehicle speed V as a parameter to provide control of eliminating a rotation speed difference and a drive force distribution difference relative to the steering angle θ as the vehicle speed becomes higher, control of increasing running stability at higher vehicle speed can be provided.

As described above, according to this example, since the brakes Ba and Bb are disposed as the engagement devices allowing respective differential motions of the left and right drive wheels 16a and 16b between the output shaft 26 of the electric motor MG and the left and right drive wheels 16a and 16b, the slip ratio of the brakes Ba and Bb can be changed to apply a rotation speed difference to the left and right drive wheels 16a and 16b as is the case with a differential device without disposing the differential device. Since the differential device can be eliminated in this way, the degree of freedom in design becomes higher and the centroid design of the electric motor MG is facilitated. Since this also eliminates the intermediate shaft that is required when the differential device is disposed on one axial side of the electric motor MG and that penetrates through an inside of the output shaft 26 of the electric motor MG to be coupled to the drive wheel 16, the degree of freedom in design is further increased.

According to this example, each of the planetary gear devices 28a and 28b is disposed between each end of the output shaft 26 of the electric motor MG and each of the left and right drive wheels 16a and 16b and the brakes Ba and Bb are brakes Ba and Bb fixing the ring gears R1 of the planetary gear devices 28a and 28b to reduce the rotation of the output shaft 26 of the electric motor MG. As a result, the planetary gear devices 28a, 28b and the brakes Ba, Bb make up the transmissions 12a, 12b (reduction gears), and the rotation of the output shaft 26 of the electric motor MG can be reduced and transmitted to the drive wheels 16a and 16b by engaging the brakes Ba and Bb to stop the rotations of the ring gears R1. When the transmissions 12a and 12b act as the reduction gears, the output torque of the electric motor MG can be made smaller and, therefore, the electric motor MG can be reduced in size. Since the engagement devices are the brakes Ba and Bb stopping the rotations of the ring gears, the device can be simplified as compared to a clutch, which couples rotating rotational elements to each other.

According to this example, the electric motor MG; the planetary gear devices 28a, 28b, and the left and right drive wheels 16a, 16b are arranged on one axis. As a result, the electric drive device 10 can be restrained from increasing in size in a radial direction.

According to this example, the planetary gear device 28a is made up of the sun gear S1 coupled to the output shaft 26 of the electric motor MG, the stepped pinion SP having the small-diameter gear 30 and the large-diameter gear 32 such that the large-diameter gear 32 is meshed with the sun gear 51, the carrier CA1 supporting the stepped pinion SP rotatably and revolvably around the sun gear S1 and coupled to the drive wheel 16, and the ring gear R1 meshed with the small-diameter gear 30 of the stepped pinion SP, and the brakes Ba and Bb are disposed between the ring gear R1 and the case 18 that is a non-rotating member. As a result, the transmission 12 (reduction gear) capable of significant speed reduction can be configured.

This example not only has the purpose of preferably controlling the torque capacities of the brakes Ba and Bb to apply a rotation speed difference to the left and right drive wheels 16a and 16b, but also can be given a function as a differential limitation device or a drive force distribution device, for example.

Another example of the present invention will be described. In the following description, the portions common with the example are denoted by the same reference numerals and will not be described.

### SECOND EXAMPLE

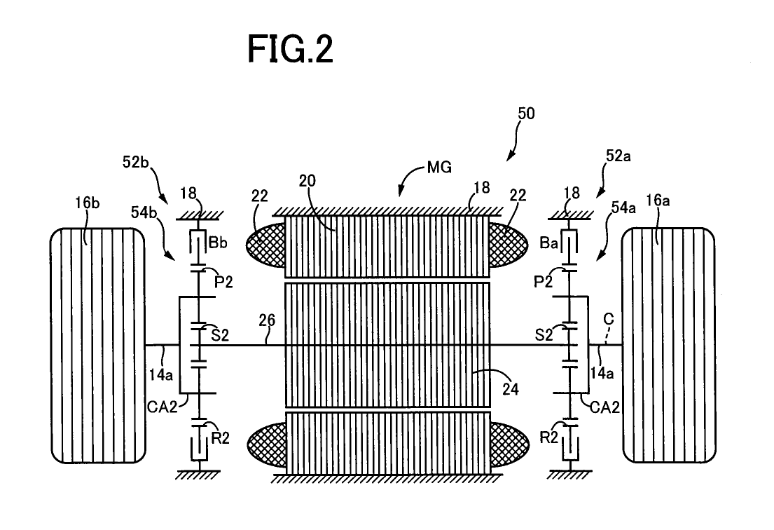

FIG. 2 is a cross-sectional view of a vehicle electric drive device 50 (hereinafter, an electric drive device 50) of another example of the present invention. Comparing the electric drive device 50 with the electric drive device 10 described above, only transmissions 52a and 52b have different structures and the other constituent elements are common. The structures of the transmissions 52a and 52b will hereinafter be described and the common portions will not be described.

The transmission 52a mainly includes a planetary gear device 54a and the brake Ba. The planetary gear device 54a consists of a single pinion type planetary gear device and includes a sun gear S2 coupled to the output shaft 26 of the electric motor MG, a carrier CA2 that supports a pinion gear P2 meshed with the sun gear S2 rotatably and revolvably around the sun gear S2 (around the axial center C) and that is coupled via the axle 14a to the drive wheel 16a, and a ring gear R2 meshed with the sun gear S2 via the pinion gear P2.

The brake Ba is disposed between the ring gear R2 and the case 18 that is a non-rotating member and has a torque capacity that can be controlled depending on the engagement oil pressure supplied in the same way as the example. For example, if no oil pressure is supplied to the brake Ba, the planetary gear device 54a is in an idling state and the power from the electric motor MG is not transmitted to the axle 14a. If an oil pressure is supplied to the brake Ba and results in complete engagement between the ring gear R2 and the case 18, the rotation of the output shaft 26 of the electric motor MG is reduced and transmitted to the axle 14a.

The transmission 52b mainly includes a planetary gear device 54b and a brake Bb. Structures of the planetary gear device 54b and the brake Bb are not changed from the planetary gear device 54a and the brake Ba described above and are therefore denoted by the same reference numerals and will not be described. In the electric drive device 50 of this example, gear ratios of the transmission 52a and the transmission 52b are the same values, and the brake Ba and the brake Bb are configured to be independently controllable.

Even when the vehicle electric drive device 50 is configured as described above, an optimum rotation speed difference can be applied to the drive wheels 16a and 16b by independently controlling the engagement oil pressures (torque capacities) of the brake Ba and the brake Bb and, therefore, the differential device can be eliminated. Since the drive force distribution of the left and right drive wheels 16a and 16b can freely be adjusted between 0 and 100%, the differential limitation function and the improvement in a turning performance of the vehicle can be achieved as is the case with the example.

### THIRD EXAMPLE

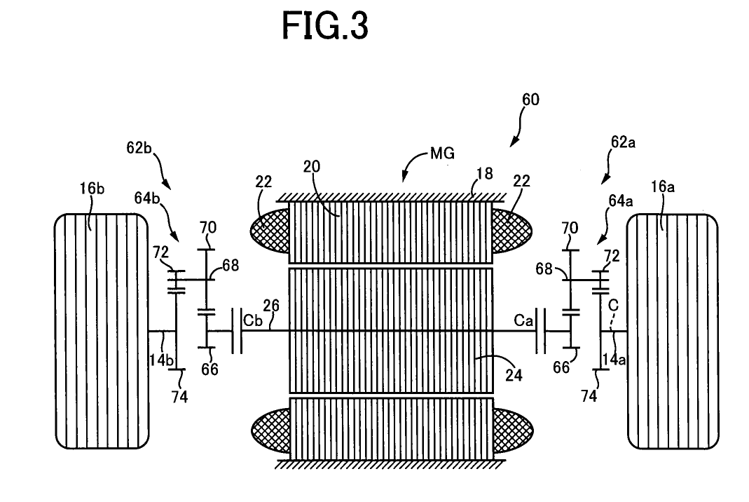

FIG. 3 is a cross-sectional view of a vehicle electric drive device 60 (hereinafter, an electric drive device 60) of yet another example of the present invention. Comparing the electric drive device 60 with the electric drive device 10 described above, only transmissions 62a and 62b have different structures and the other constituent elements are common. The structures of the transmissions 62a and 62b will hereinafter be described and the common portions will not be described.

The transmission 62a mainly includes a reduction gear device 64a and a clutch Ca that is an engagement device. The reduction gear device 64a includes an input gear 66 coupled via the clutch Ca to the output shaft 26 of the electric motor MG, a large-diameter gear 70 and a small-diameter gear 72 disposed on a counter shaft 68 parallel to the axial center C, and an output gear 74 connected to the output shaft 14a. The input gear 66 and the large-diameter gear 70 are meshed with each other to form a first reduction gear pair, and the small-diameter gear 72 and the output gear 74 are meshed with each other to form a second reduction gear pair. Therefore, the transmission 62a reduces rotation of the input gear 66 to output the rotation to the output shaft 14a coupled to the output gear 74.

The clutch Ca is disposed between the output shaft 26 of the electric motor MG and the transmission 62a. The clutch Ca is a well-known multi-plate clutch having an engagement state controlled by a supplied oil pressure (engagement oil pressure) as is the case with the brake Ba. A torque capacity of the clutch Ca is controlled by controlling the engagement oil pressure of the clutch Ca. For example, if no oil pressure is supplied to the clutch Ca, since the torque capacity is zero and the clutch Ca is opened, no drive force is transmitted to the drive wheel 16a. If the engagement oil pressure of the clutch Ca becomes higher and the torque capacity of the clutch Ca exceeds the output torque of the electric motor MG, the clutch Ca is completely engaged and the rotation of the output shaft 26 of the electric motor MG is reduced and transmitted via the transmission 62a to the output shaft 14a.

The transmission 62b mainly includes a planetary gear device 64b and a clutch Cb that is an engagement device. Structures of the planetary gear device 64b and the clutch Ca are not changed from the planetary gear device 64a and the clutch Ca described above and are therefore denoted by the same reference numerals and will not be described. In the electric drive device 60 of this example, gear ratios of the transmission 62a and the transmission 62b are the same values, and the clutch Ca and the clutch Cb are configured to be independently controllable.

Even when the vehicle electric drive device 60 is configured as described above, an optimum rotation speed difference can be applied to the drive wheels 16a and 16b by independently controlling the engagement oil pressures (torque capacities) of the clutch Ca and the clutch Cb and, therefore, the differential device can be eliminated. Since the drive force distribution of the left and right drive wheels 16a and 16b can freely be adjusted between 0 and 100%, the function of the differential limitation device and the improvement in a turning performance of the vehicle can be achieved as is the case with the example.

Although the examples of the present invention have been described in detail with reference to the drawings, the present invention is applicable in other forms.

For example, although hydraulic friction engagement devices are used as the brakes B and the clutches C in the examples, this is not a limitation of the present invention and any of those capable of continuously varying a torque capacity, for example, electromagnetic clutches, can be used as needed.

Although a planetary gear device 28 having the stepped pinion SP and the single pinion type planetary gear device 54 are used in the examples, this is not necessarily a limitation. For example, a double pinion type planetary gear device may be used and configurations of the planetary gear devices may be changed as needed. The devices are not necessarily limited to reduction gears and may act as speed-increasing gears.

Although the transmissions 62a and 62b are made up of the reduction gear devices 64a, 64b, and the clutches Ca, Cb in the example, the transmissions 62a and 62b are not necessarily required, and the output shaft 26 of the electric motor MG may directly be coupled to the drive wheels 16a and 16b via the clutches Ca and Cb. The reduction gear devices 64 are not a limitation and may be those increasing the rotation of the electric motor MG.

Although all the vehicle electric drive devices 10, 50, and 60 are configured to be symmetrical in the examples, the symmetrical configuration is not necessarily a limitation.

Although the planetary gear devices and meshing gear devices are used as the transmissions in the examples, another configuration may be used as long as the configuration can achieve a gear shift.

The above description is merely an embodiment and the present invention may be implemented in variously modified and improved forms based on the knowledge of those skilled in the art.

### NOMENCLATURE OF ELEMENTS

10, 50, 60: vehicle electric drive device 16a: drive wheel 16b: drive wheel 26: output shaft 28a: planetary gear device 28b: planetary gear device MG: electric gear Ba: brake (engagement device) Bb: brake (engagement device) Ca: clutch (engagement device) Cb: clutch (engagement device)

1-3. (canceled)

4. A vehicle electric drive device having an electric motor coupled to drive wheels in a power transmittable manner to drive left and right drive wheels with the electric motor,
the electric motor having an output shaft coupled at both respective ends to the left and right drive wheels,
the vehicle electric drive device being disposed with an engagement device between each end of the output shaft of the electric motor and each of the left and right drive wheels, the engagement device allowing a differential motion of each of the left and right drive wheels,
the vehicle electric drive device being disposed with a planetary gear device between each end of the output shaft of the electric motor and each of the left and right drive wheels,
the engagement device being a brake fixing one rotating element of the planetary gear device to reduce rotation of the output shaft of the electric motor,
the planetary gear device being made up of the sun gear coupled to the output shaft of the electric motor, the stepped pinion having the small-diameter gear and the large-diameter gear such that the large-diameter gear is meshed with the sun gear, the carrier supporting the stepped pinion rotatably and revolvably around the sun gear and coupled to the drive wheel, and the ring gear meshed with the small-diameter gear of the stepped pinion, and the engagement devices being disposed between the ring gear and a non-rotating member.

5. The vehicle electric drive device of claim 4, wherein the electric motors, the planetary gear devices, and the left and right drive wheels are arranged on one axis.
